(19) United States
(12) Patent Application Publication
(10) Pub. No.: US 2019/0360310 A1
(43) Pub. Date: Nov. 28, 2019

(54) Downhole Trimming Tool

(71) Applicant: National Oilwell Varco, L.P., Houston, TX (US)

(72) Inventors: Lydia Mata Mireles, Houston, TX (US); Cesar J. Gonzalez, Jr., Katy, TX (US)

(73) Assignee: National Oilwell Varco, L.P., Houston, TX (US)

(21) Appl. No.: 16/152,367

(22) Filed: Oct. 4, 2018

Related U.S. Application Data
(60) Provisional application No. 62/676,705, filed on May 25, 2018.

(51) Int. Cl. E21B 41/00; E21B 33/06

(52) U.S. Cl. CPC E21B 41/00; B23C 3/124; E21B 33/06

(57) ABSTRACT

A trimming tool suitable for trimming material from within a central opening of an annular seal member includes a tubular member extending along a tool axis, a cutter coupled to move with the tubular member, and a first and a second debris catcher mounted on the tubular member. The cutter includes a first cutting edge oriented to cut when the tubular member is moved in a first direction along the tool axis, and a second cutting edge oriented to cut when the tubular member is moved in a second direction along the tool axis. Each debris catcher includes a receptacle that is open toward the cutter and includes an outer surface with a tapered segment. The cutter is mounted to the tubular member at a position between the first and second debris catchers.

### CROSS-REFERENCE TO RELATED APPLICATIONS

This application claims benefit of U.S. provisional patent application Ser. No. 62/676,705 filed May 25, 2018, and entitled “Downhole Trimming Tool,” which is hereby incorporated herein by reference in its entirety for all purposes.

### STATEMENT REGARDING FEDERALLY SPONSORED RESEARCH OR DEVELOPMENT

Not applicable.

### BACKGROUND

### Field of the Disclosure

This disclosure relates generally to oil well maintenance. More particularly, it relates to apparatus and methods for maintaining seals in situ at oil wells. Still more particularly, this disclosure relates to an apparatus and methods for modifying or repairing seals installed within equipment at oil wells.

### Background to the Disclosure

Equipment connected within or above a well bore of an oil well commonly includes annular seals that allow a pipe segment, a downhole tool, or a string of tubular members to extend through the equipment while sealing around the outer surface of the string to prevent fluid leakage. A spherical blowout preventer (SBOP) at a wellhead is an example of a piece of equipment having an annular seal that benefits from inspection, maintenance, or repair. As tubular members pass through or rotate within the annular seal, the seal eventually becomes distorted or worn, which tends to lessen its capability to seal or may make it difficult for a tubular member to enter or pass through the seal. Maintenance for the seal conventionally involves removing the tubular string from the piece of equipment and opening the equipment or removing the equipment (e.g., the SPOB) from the wellhead. These “downtime” activities consume additional time and add risk and financial cost. Finding new ways to maintain or repair annular seals at oil wells would be beneficial to the industry.

### BRIEF SUMMARY OF THE DISCLOSURE

These and other needs in the art are addressed in one embodiment by a trimming tool suitable for trimming material from within a central opening of an annular seal member. In an embodiment, the trimming tool includes a tubular member extending along a tool axis. In addition, the trimming tool includes a cutter coupled to move with the tubular member. The cutter includes a first cutting edge oriented to cut when the tubular member is moved in a first direction along the tool axis, and a second cutting edge oriented to cut when the tubular member is moved in a second direction along the tool axis that is different from the first direction. Further, the trimming tool includes a first debris catcher and a second debris catcher mounted on the tubular member. Each debris catcher comprises a receptacle that is open toward the cutter, and comprises an outer surface that includes a tapered segment. The cutter is mounted to the tubular member at a position between the first and second debris catchers.

In another embodiment, a trimming tool includes an elongate pipe string extending along a tool axis and having first and second spaced-apart ends. In addition, the trimming tool includes a cutter positioned on the pipe string at a location that is between the first end and the second end. The cuter comprises a cylindrical outer surface and at least one cutting edge that extend about the tool axis. Further, the trimming tool includes a debris catcher mounted on the pipe string at a location between the cutter and one of the first and second ends. The debris catcher comprises an inner surface forming a receptacle that is open in the direction facing the cutter, and comprises an outer surface having an outer profile that includes at least one tapered segment.

In another embodiment, a trimming tool includes a pipe string extending along a longitudinal axis and a cutter mounted on the pipe string. The cutter includes a first cutting edge facing generally in a first axial direction along the longitudinal axis. In addition, the trimming tool includes a first debris catcher mounted on the pipe string at a location spaced-apart from the cutter and extending circumferentially around the pipe string. The debris catcher comprises a receptacle that faces the first cutting edge.

Thus, embodiments described herein include a combination of features and characteristics intended to address various shortcomings associated with certain prior devices, systems, and methods. The various features and characteristics described above, as well as others, will be readily apparent to those of ordinary skill in the art upon reading the following detailed description, and by referring to the accompanying drawings.

### BRIEF DESCRIPTION OF THE DRAWINGS

For a detailed description of the disclosed exemplary embodiments, reference will now be made to the accompanying drawings, wherein:

FIG. 1 shows a side view, in cross-section, of a trimming tool positioned above and partially inside a spherical blowout preventer in accordance with principles described herein.

FIG. 2 shows a side view of an embodiment of the trimming tool of FIG. 1, including a cutting tool and an upper and a lower debris catcher in accordance with principles described herein;

FIG. 3 shows a side view in cross-section of the trimming tool of FIG. 2;

FIG. 4 shows an upper portion of the trimming tool of FIG. 3;

FIG. 5 shows a mid-portion of the trimming tool of FIG. 3;

FIG. 6 shows a lower portion of the trimming tool of FIG. 3;

FIGS. 7-9 show various views of the cutting tool of the trimming tool of FIG. 2 in accordance with principles described herein;

FIGS. 10 and 11 show a perspective view and a perspective view in cross-section, respectively, of the debris catcher of the trimming tool of FIG. 2 in accordance with principles described herein;

FIG. 12 shows a side view, in cross-section, of the trimming tool of FIG. 1 positioned inside the spherical blowout preventer;

FIG. 13 shows a side view, in cross-section, of the trimming tool of FIG. 1 at another position inside the spherical blowout preventer;

FIG. 14 shows a side view, similar to of FIG. 2, of the trimming tool with the upper and lower debris catchers axially separated further from the cutting tool and further from each other as compared to FIG. 2;

FIG. 15 shows a side view in cross-section of the trimming tool arrangement of FIGS. 14; and

FIGS. 16 and 17 show perspective views of another embodiment of a trimming tool in accordance with principles described herein.

### NOTATION AND NOMENCLATURE

The following description is exemplary of certain embodiments of the disclosure. One of ordinary skill in the art will understand that the following description has broad application, and the discussion of any embodiment is meant to be exemplary of that embodiment, and is not intended to suggest in any way that the scope of the disclosure, including the claims, is limited to that embodiment.

The Figures are not drawn to-scale. Certain features and components disclosed herein may be shown exaggerated in scale or in somewhat schematic form, and some details of certain elements may not be shown in the interest of clarity and conciseness. In some of the Figures, in order to improve clarity and conciseness, one or more components or aspects of a component may be omitted or may not have reference numerals identifying the features or components. In addition, within the specification, including the drawings, like or identical reference numerals may be used to identify common or similar elements.

As used herein, including in the claims, the terms “including” and “comprising,” as well as derivations of these, are used in an open-ended fashion, and thus are to be interpreted to mean “including, but not limited to . . . .” Also, the term “couple” or “couples” means either an indirect or direct connection. Thus, if a first component couples or is coupled to a second component, the connection between the components may be through a direct engagement of the two components, or through an indirect connection that is accomplished via other intermediate components, devices and/or connections. The recitation “based on” means “based at least in part on.” Therefore, if X is based on Y, then X may be based on Y and on any number of other factors. The word “or” is used in an inclusive manner. For example, “A or B” means any of the following: “A” alone, “B” alone, or both “A” and “B.” In addition, the word “substantially” means within a range of plus or minus 10% and encompasses embodiments in which a measurement or condition is precise or 100%.

In addition, the terms “axial” and “axially” generally mean along or parallel to a given axis, while the terms “radial” and “radially” generally mean perpendicular to the axis. For instance, an axial distance refers to a distance measured along or parallel to a given axis, and a radial distance means a distance measured perpendicular to the axis. Furthermore, any reference to a relative direction or relative position is made for purpose of clarity, with examples including “up,” “upper,” “upward,” “down,” “downward,” and “lower,” For example, a relative direction or a relative position of an object or feature may pertain to the orientation as shown in a Figure or as described. If the object or feature were viewed from another orientation or were implemented in another orientation, it may then be helpful to describe the direction or position using an alternate term.

### DETAILED DESCRIPTION OF THE DISCLOSED EXEMPLARY EMBODIMENTS

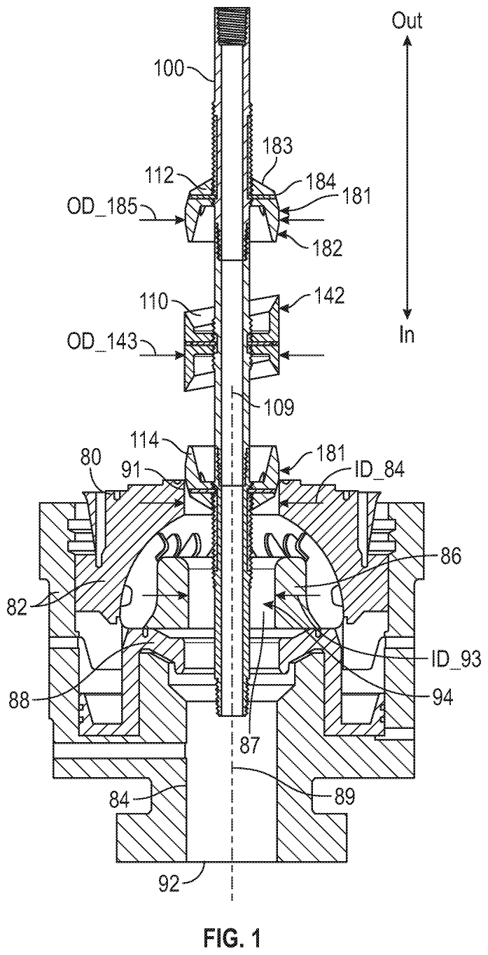

Referring to FIG. 1, in an exemplary embodiment, a trimming tool 100 is shown positioned above and partially inside a spherical blowout preventer (BOP) 80. BOP 80 includes a housing 82 having a central bore or opening 84 and containing an annular, elastomeric packer or packing element 86 and a concentric annular piston 88, both surrounding the opening 84. Central opening 84 extends along a central or longitudinal BOP axis 89 from an upper port 91 to a lower port 92 and is characterized by an inner diameter ID_84. Packing element 86 includes a central aperture 87 having an inner diameter, ID_93 and an inner surface 94. During operation, element 86 may be squeezed radially inward such that inner surface 94 engages a tubular member. Due to use or age, the shape of central aperture 87 may be come distorted, giving cause for the use of tool 100. BOP 80 is an example of a piece of equipment having an annular seal member (such as packing element 86 as an example) that may be maintained or repaired by tool 100. In various installations, BOP 80 is coupled above or below other components of a wellhead on an oil well. Tool 100 extends along central or longitudinal tool axis 109 aligned with BOP axis 89. Tool 100 includes a cylindrical cutting blade or cutter 110 that is designed to trim non-uniform or enlarged portions from central aperture 87 of element 86 to make aperture 87 more uniform in diameter, for example, to make it more closely equal to ID_93. In a mode of operation, tool 100 is pushed or pulled into or through BOP 80 and packing element 86 without rotation. Another mode of operation may include rotation of tool 100.

Trimming tool 100 is designed to trim/cut rubber or other elastomer from annular packing elements, such as packing element 86, employed in a spherical blowout preventer, such as BOP 80, or another type of BOP when elastomeric material of the packing elements has come to protrude into the central opening of the BOP and restrict full bore tools from passing downhole through the occluded opening. The BOP may be a member of a subsea pressure control stack, for example. By using tool 100, a user will be able to avoid pulling the subsea pressure control stack up to the surface in order to replace the packing element. Instead, while the stack remains in place (e.g., mounted at a wellhead) the tool can trim and remove elastomer that has partially occluded the central aperture of the BOP without the time consuming and very costly retrieval and reinstallation process otherwise required. Trimming tool 100 is designed to be connected to the user's drilling pipe and be sent down hole. During operation, trimming tool 100 is lowered to the appropriate location and is pushed and pulled through the packing element. The features of tool 100 that provide this functionality are described in more detail below.

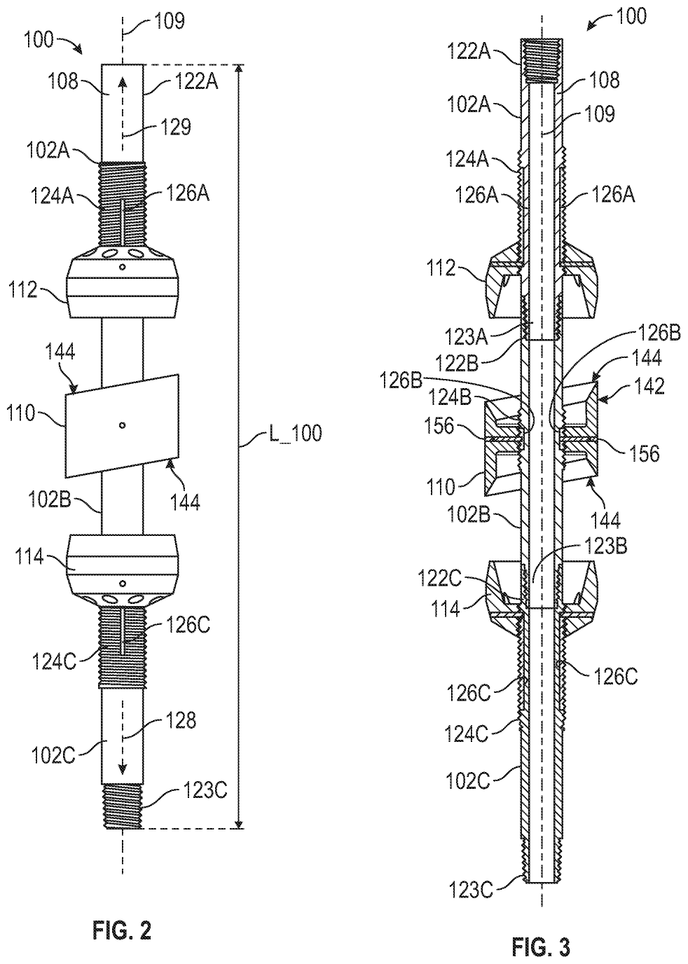

Referring to FIG. 2 and FIG. 3, trimming tool 100 includes a tubular member 108 extending along a tool axis 109 and includes the cutter 110 and an upper and a lower debris catcher or basket 112, 114 mounted on the tubular member 108. Tubular member 108 may be, as examples, a pipe segment or pipe string comprising multiple pipe segments. In this embodiment, the tubular member 108 is a pipe string 108 that includes upper, central, and lower pipe sections 102A, 102B, 102C threadedly engaged together, end-to-end. As assembled, pipe string 108 defines the length L_100 of tool 100. Each section of pipe 102A, 102B, 102C has threading 124A, 124B, 124C, respectively, on the outside, onto which the debris catchers 112, 114 or cutter 110 may be threaded. The threading allows the debris catcher 112, 114 to be positioned at different distances from the cutter, allowing axial adjustment of the components. Cutter 110 is attached to central pipe section 102B, upper debris catcher 112 is attached to the upper pipe section 102A, and lower debris catcher 114 is attached to the lower pipe section 102C.

In the embodiment shown, upper pipe 102A extends from an upper, threaded box end 122A to a threaded pin end 123A and includes the external threads or threaded segment 124A and a pair of exterior, longitudinal grooves 126A extending radially inward from the outer surface of pipe 102A and extending axially through a portion of threads 124A. External threads 124A begin at a location proximal pin end 123A and extend toward box end 122A. Threads 124A and grooves 126 terminate approximately midway between ends 123A, 122A. Central pipe 102B extends from an upper, threaded box end 122B to a threaded pin end 123B and includes the external threads or threaded segment 124B and a pair of exterior, longitudinal grooves 126C extending axially through a portion of threads 124B. External threads 124B are disposed midway between pipe ends 122B, 123B. Like upper pipe 102A lower pipe 102C extends from an upper, threaded box end 122C to a threaded pin end 123C and includes the external threads or threaded segment 124C and a pair of exterior, longitudinal grooves 126C extending axially through a portion of threads 124C. Differing from upper pipe 102A, external threads 124C of lower pipe 122C begin at a location proximal box end 121C and extend toward pin end 123C. Threads 124A and grooves 126 terminate approximately midway between ends 122A, 123A. Thus, pipe string 108 extends from a lower end 123C to an upper end 122A, which are spaced-apart along tool axis 109. A downward direction 128 for tool 100 along axis 109 may be defined as being directed toward or beyond lower end 123C. An upward direction 129 for tool 100 along axis 109 may be defined as being directed toward or beyond upper end 122A.

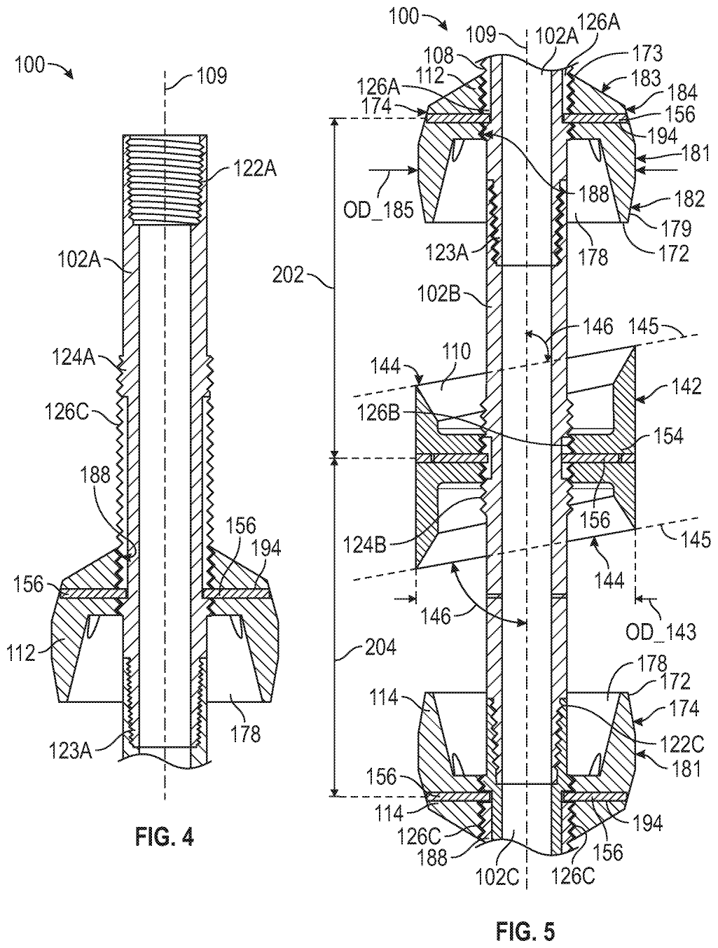

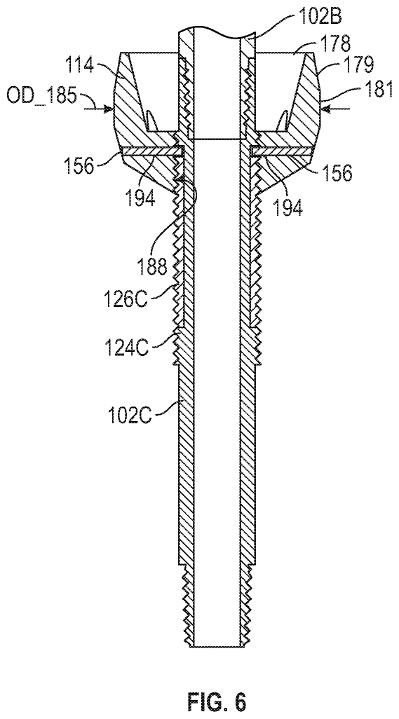

FIGS. 4-6 show closer sectional views of tool 100 similar to FIG. 3 but divided into three sections.

Referring to FIG. 5, cutter 110 includes a generally cylindrical, outer surface 142 as well as a circumferentially-extending cutting edge 144 at each axial end. The lower cutting edge 144 faces generally in the downward direction 129 and is thereby oriented to cut when pipe string is moved in the downward direction 129. The upper cutting edge 144 faces generally in the upward direction 128 and is thereby oriented to cut when pipe string is moved in the upward direction 128. Outer surface 142 has an outside diameter, OD_143, selected to achieve a desired inside diameter, ID_93 when cutting packing element 86 (FIG. 1). Each cutting edge 144 defines a plane 145 that is angled relative to the tool axis 109. The downwardly facing cutting edge 144 and its plane 145 are axially spaced-apart from the upwardly facing cutting edge 144 and its plane 145. The angle of plane 145 relative to axis 109 will be identified by the reference numeral 146. In some embodiments, angle 146 has a value that is less than 90° relative to tool axis 109. In some embodiments, angle 146 has a value between 60° to 80° relative to tool axis 109. In the exemplary embodiment shown in FIGS. 2, 3, and 5, angle 146, is approximately 70 degrees. In some of these examples, the plane 145 and cutting edge 144 are not perpendicular with respect to the tool axis 109; this configuration provides enhanced efficiency and ease of cutting. In some other embodiments, angle 146 is 90 degrees, so plane 145 and cutting edge 144 are perpendicular to tool axis 109. The planes 145 defined by the first and second cutting edges 144 may be parallel to one another as shown in FIGS. 2, 3, and 5 or may have different values for their angles 146. In some embodiments, one cutting edge 144 may be perpendicular to the axis, and another cutting edge 144 may be angled relative to the axis at an angle 146 that is not 90°, as examples. The orientation of planes 145 and cutting edges 144 relative to axis 109 may be similarly described in terms of the supplemental angle of angle 146.

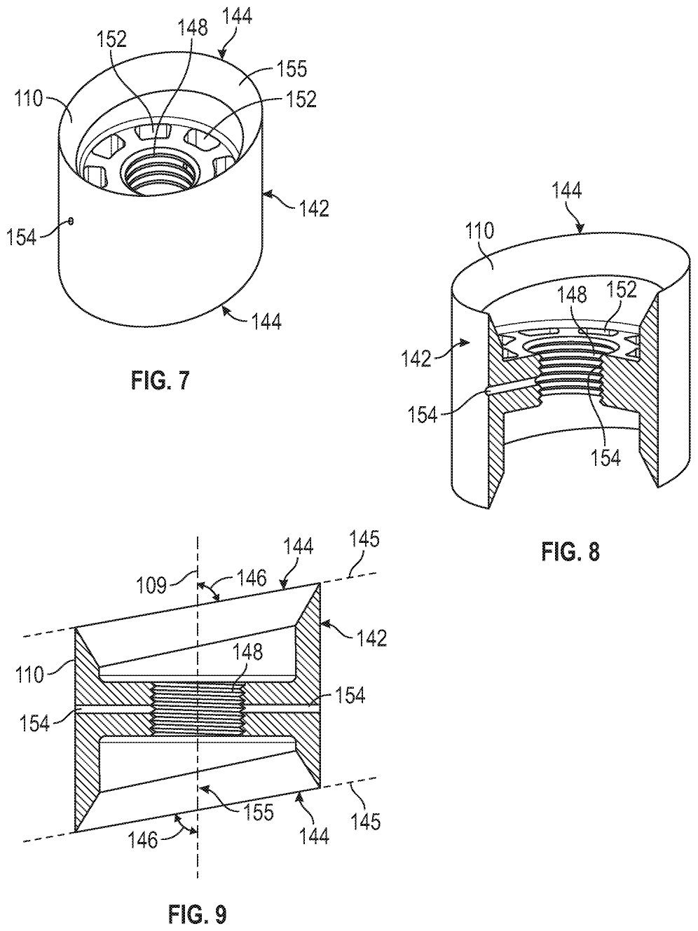

As shown in FIGS. 7-9, cutter 110 includes a central threaded aperture 148 disposed about the central or longitudinal axis 109, and a plurality of pass-through holes 152 positioned about the aperture 148 and axis 109. Threaded aperture 148 is provided to engage threadedly the threaded segment 124B on the outer surface of the central pipe section 102B. The pass-through bores 152 provide a means for fluid to pass-through the cutter 110 as it is moved up and down within a blowout preventer and thereby minimize resistance created by back pressure. Each cutting edge 144 is formed by an internal, tapered surface 155 that extends inward from outer surface 142 toward aperture 148. With this configuration, the diameter of cutting edge 144 matches the diameter of outer surface 142. Cutting edges 144 extend about the tool axis 109 for 360 degrees. Angle 146 (reference numeral) is again shown between plane 145 and axis 109.

As best shown in FIGS. 8 and 9, cutter 110 includes first and second radially extending bores 154 to receive pins. Referring to FIG. 5, once cutter 110 is threaded into position on central pipe section 102B, pins 156 are inserted radially into the bores 154 of cutter 110 and are received within grooves 126B of pipe 102B to fasten cutter 110, preventing rotation and axial movement of cutter 110 relative to the pipe section 102B and pipe string 108 when assembled.

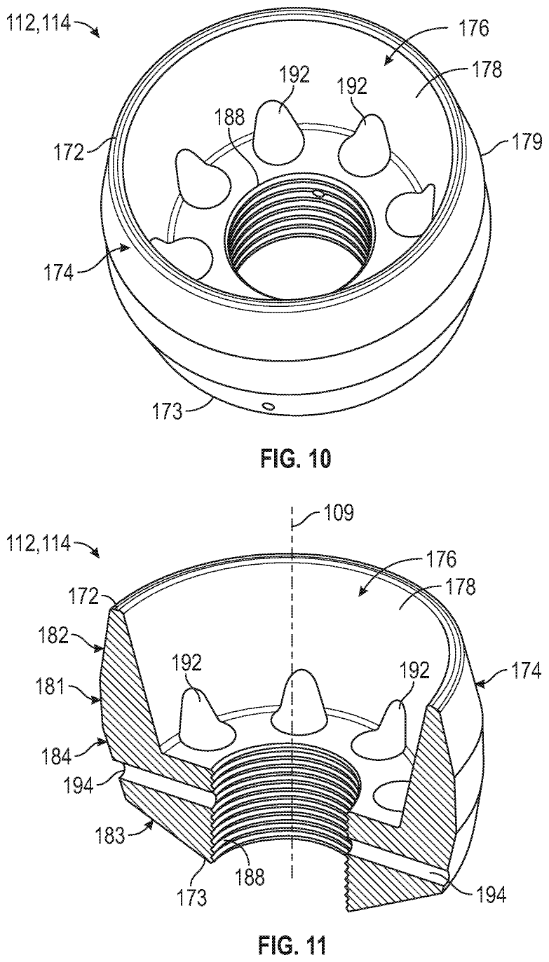

Referring to FIGS. 10 and 11 as well as FIG. 1, each debris catcher or basket 112, 114 extends along a central or longitudinal axis 109 from a first or open end 172 to a second end 173 and includes an outer surface 174 and an inner surface 176. Debris catchers 112, 114 are tapered or chamfered along their outer surface 174 to help tool 100 to centralize properly and pass-through a BOP 80 (e.g., FIG. 1), ensuring the cutter does not get caught on another component while cutting the protruding material of a packing element 86. The chamfered outer surface 174 are configured to push any protruding rubber of the element 86 out-of-the-way (radially outward) to allow the debris catcher 112, 114 to pass through element 86. After catcher 112, 114 passes through, the resilient element 86 springs back (radially inward) and any inwardly-protruding material of element 86 gets caught and trimmed by the cutter 110 as cutter 110 passes through packing element 86. The inner surface 176 defines a vessel or receptacle 178 at open end 172 for capturing and retaining therein pieces of an elastomeric (e.g., rubber or polymer) packer (e.g., packer 86 in FIG. 1) after the pieces have been sheared from the inner diameter of the packer by cutter 110 as the tool moves either down through a blowout preventer or is pulled back up through the BOP.

As with cutter 110, each debris catcher 112, 114 includes a central threaded aperture 188 and may be thereby threaded into position on a respective threaded pipe surface 124A, 124C (e.g., FIG. 5). Multiple, longitudinal pass-through holes 192 are disposed about threaded aperture 188 to allow fluid to pass, and a first and a second radial bores 194 extend radially from outer surface 174 to aperture 188 to receive pins. FIGS. 4-6 show debris catchers 112, 114 axially positioned at a selected location along a threaded segment 124A, 124C with apertures 188 threadedly received on segments 124A, 124C. Pins 156 are inserted radially into the bores 194 and into longitudinally extending grooves 126A, 126C of pipes 102A, 102C. As a result, debris catchers 112, 114 retain their axial and rotational position relative to the corresponding pipe section 102A, 102C and pipe string 108 when assembled. Receptacles 178 are accessible through open ends 172, which face toward cutter 110 and blades 144.

Referring to FIG. 5, the outer surface 174 of each debris catcher 112, 114 includes an outer surface profile 179 with multiple segments. These include a generally cylindrical and centrally-positioned segment 181, as well as tapered (frustoconical) segments 182, 183 at each end 172, 173, respectively, of the debris catcher. Profile 179 includes a third tapered (frustoconical) segment 184 disposed between segment 183 and segment 181. In the profile view, segments 182, 183, 184 taper radially inward toward the tool axis 109 as each extends from cylindrical segment 181 toward one of the ends 172, 173. Thus, segment 181 defines the largest outer diameter of debris catcher 112, 114. Referring to FIG. 5 and FIG. 1, the cylindrical segment 181 of a debris catcher 112, 114 has an outside diameter, OD_185, that is substantially the same as the inside diameter, ID_84, of central opening 84 in BOP 80 and is similar in magnitude to the inside diameter, ID_93 of the central aperture 87 of the packing element 86 in BOP 80. In some embodiments, the OD_185 of cylindrical segment 181 is greater than the outside diameter, OD_143, of the cylindrical, outer surface 142 of cutter 110. In various embodiments, OD_185 is greater than, equal, or less than the outside diameter, OD_143 of cutter 110. During operation, the tapered segments 182, 183, 184 guide the tool down through and then back up through the opening 84 of BOP 80. Generally cylindrical segments 181, are sized to keep cutter 110 centralized with respect to opening 84. Thus, during operation, debris catchers 112, 114 may be utilized not only to catch and retain debris, but also to serve as centralizers to keep cutter 110 appropriately positioned within the packing element 86 before and while cutting takes place. As such, the debris catchers 112, 114 are both centralizers as well as receptacles for retaining portions of the elastomer that may be sheared by cutter 110.

In the example of FIG. 5, the open end 172 of upper debris catcher 112 is, in general, axially aligned with threads of pin end 123A, and radial bores 194 and pins 156 are axially aligned with the lower ends of grooves 126A. As such, debris catcher 112 is disposed at the closest possible location to cutter 110 for this embodiment. In this example, the open end 172 of lower debris catcher 114 is, in general, axially aligned with threads of box end 122C, and radial bores 194 and pins 156 are axially aligned with the upper ends of grooves 126C. As such, debris catcher 114 is disposed at the closest possible location to cutter 110 for this embodiment. The axial distance between each debris catcher 112, 114 and cutter 110 along pipe string 102 is indicated by reference numeral 202, 204, respectively. In this embodiment, distances 202, 204 are selected to extend between bores 194 of debris catchers 112, 114 and bores 154 of cutter 110, but other locations for measuring distances 202, 204 may be adopted. The distance between debris catchers 112, 114 is the sum of the distances 202, 204. The distance 202, 204 between each debris catcher 112, 114, respectively, and cutter 110 along pipe string 102 can be changed if desired. This adjustability is facilitated by the threaded connections between the debris catchers 112, 114 and their respective pipe sections 102A, 102C and by grooves 126A, 126C. Because threaded segments 124A, 124C and grooves 126A, 126C are longer than central apertures 188 of debris catchers 112, 114, the debris catchers 112, 114 may be moved and may be held at a variety of axial positions along pipe sections 102A, 102C, respectively, and along pipe string 108. With this arrangement, debris catchers 112, 114 may be placed at different distances from cutter 110. Moreover, the distance 202 between cutter 110 and the upper debris catcher 112 can be different than the distance 204 between cutter 110 and the lower debris catcher 114.

Considering the operation of trimming tool 100, FIG. 1 shows tool 100 positioned above and partially inside the BOP 80 and with the lower debris catcher 114 at upper port 91 of opening 84. This view represents a situation in which trimming tool 100 has either begun to enter the BOP 80 or is being removed and has cleared (moved upward and beyond) packing element 86 and annular piston 88.

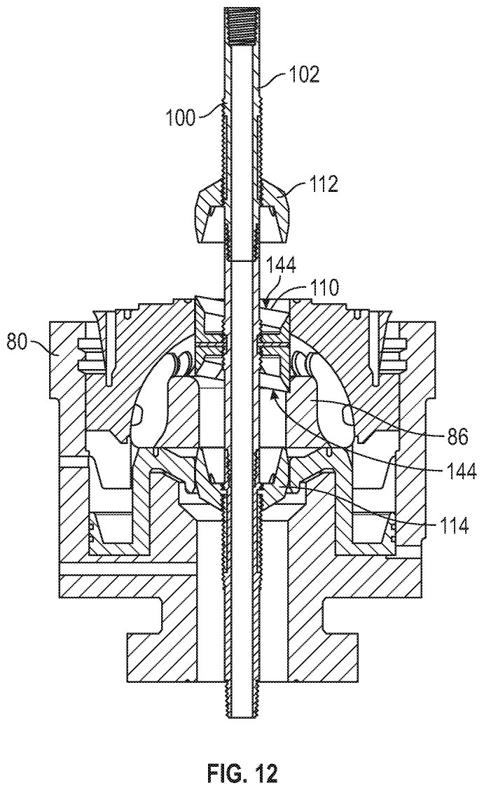

In FIG. 12, tool 100 is shown with cutter 110 disposed just above the elastomeric packing element 86 inside BOP 80. In the case wherein the tool is being pushed downward through BOP 80, cutter 110 has not yet contacted packing element 86 to sever portions of the element 86. In the situation wherein the tool has been pushed through and is now being pulled back up, cutter 110 has passed twice through the opening 84 of the packing element 86 and, when appropriate, has cut occluding material with both the lower cutting edge 144, as the tool is pushed downward, and with the upper cutting edge 144, as the tool is pulled upward.

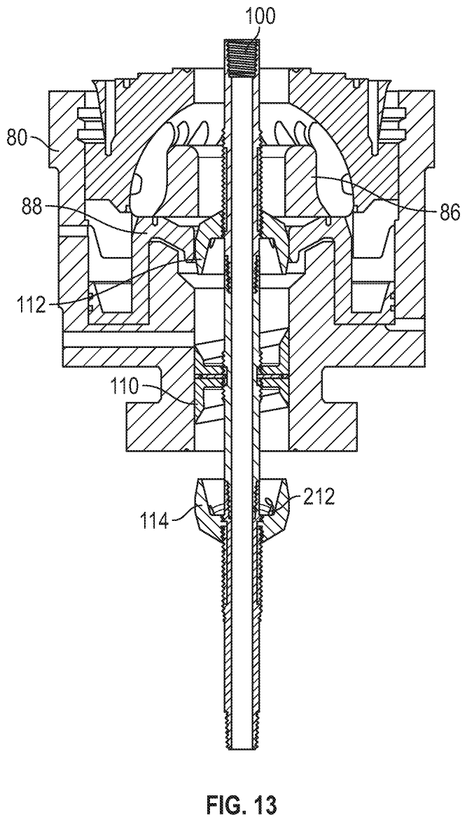

Referring to the cross-sectional view of FIG. 13, tool 100 is shown within BOP 80 such that the upper debris catcher 112 is disposed just below the packing element 86 and generally aligned with piston 88. FIG. 13 represents a situation wherein the tool has been passed once, downward, through the packing element 86 with cutter 110 having removed elastomeric material 212 that had been occluding the central bore 87. The removed elastomeric material 212 has been captured in lower debris catcher 114.

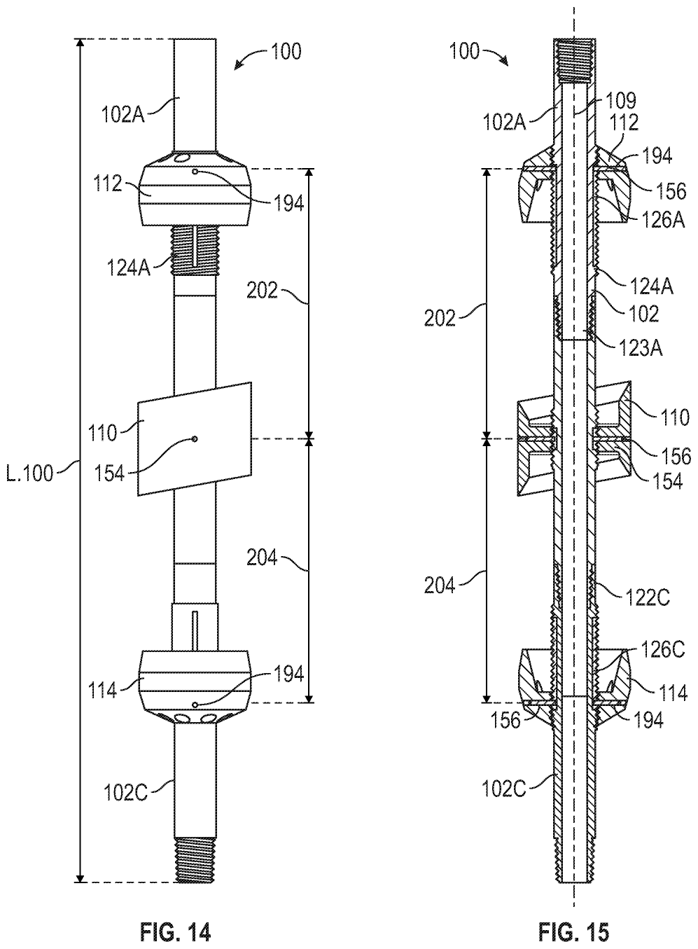

Referring now to FIG. 14 and FIG. 15, as stated above, the distance 202, 204 between each debris catcher 112, 114, respectively, and cutter 110 along pipe string 102 can be changed if desired. In this example, debris catchers 112, 114 are spaced apart further from each other and further from cutter 110 than in FIGS. 1 and 5. In FIG. 14 and FIG. 15, upper debris catcher 112 is disposed along upper pipe section 102A and its threaded segment 124A at a location distal pin end 123A. Radial bores 194 and pins 156 of debris catcher 112 are axially aligned with the upper ends of grooves 126A. Lower debris catcher 114 is disposed along lower pipe section 102C and its threaded segment 124C at a location distal box end 122C. Radial bores 194 and pins 156 of debris catcher 114 are axially aligned with the lower ends of grooves 126C. Depending on the distances between components in BOP 80 (e.g., distances between opening 84, packing element 86, and piston 88 along BOP axis 89; FIG. 1), in various embodiments, tool 100 may be used while in the short configuration of FIGS. 1 and 5 or may be used while in the extended configuration of FIGS. 14 and 15. The terms “short configuration” and “extended configuration” refer to the distances between debris catcher 112, cutter 110, and debris catcher 114. Other intermediate distances 202, 204 may be selected for the components of tool 100. The length L_100 of tool 100 remains unchanged.

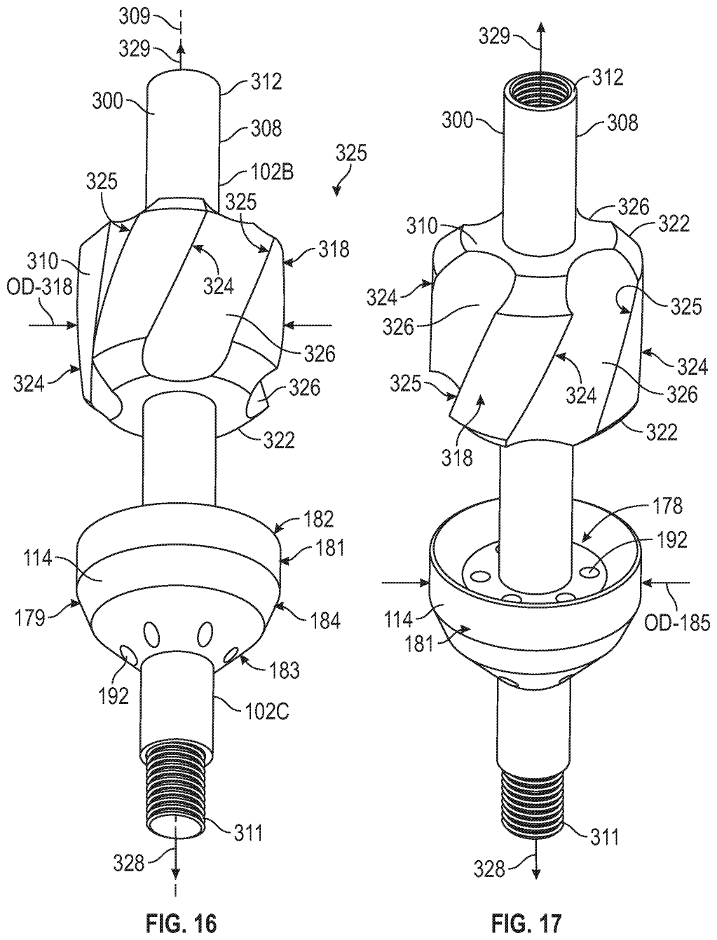

FIGS. 16 and 17 show an alternative trimming tool. In this embodiment, a tool 300 includes a lower centralizer/debris catcher/basket 114 and a cutter 310 coupled to a tubular member or pipe string 308 that extends along a central or longitudinal axis 309 from a lower, pin end 311 to an upper, box end 312. Upper end 312 is axially spaced-apart from lower end 311. A downward direction 328 for tool 100 along axis 309 may be defined as being directed toward or beyond lower end 311. An upward direction 329 for tool 100 along axis 309 may be defined as being directed toward or beyond upper end 312. As an example, tool 300 is configured of operating in BOP 80 (FIG. 1) to trim the aperture 87 of packer or packing element 86 while BOP 80 is mounted to a wellhead. During operation, tool axis 309 would be aligned with BOP axis 89. In various embodiments, pipe string 308 is similar to sting 108 of FIG. 3, being formed from a plurality of pipe sections 102B, 102C or a plurality of pipe sections 102A, 102B, 102C, as examples. Debris catcher 114 is as previously described and includes, as examples, a receptacle 178, multiple pass-through holes 192, and an outer surface profile 179, which includes segments 182, 183, 184 extending axially and tapering inward from a cylindrical and centrally-positioned segment 181. Segment 181 has an outside diameter, OD_185. Debris catcher 114 coupled along pipe string 308 as previously described or may be mounted in another fashion. Debris catcher 114 is axially spaced-apart from cutter 310. Cutter 310 of FIGS. 16 and 17 is threadedly coupled to pipe section 102B and is coupled to inhibit axial movement and rotation relative to pipe string 308. Although not shown, tool 300 may also include an upper debris catcher/centralizer 112 as previously described. In some embodiments of tool 300, the position of the debris catcher or catchers is axially adjustable along pipe string 308.

In this embodiment, cutter 310 and is formed similar to a reaming tool as is used to ream a borehole. Cutter 310 includes an outer surface 318, a tapered upper and lower portions 322 to guide cutter 110 into aperture 87 of the packing element 86 (FIG. 1), and a plurality of diagonally-extending cutting edges 324, 325 at outer surface 318. The plurality of cutting edges 324 face generally in the downward direction 328 and are thereby oriented to trim the elastomer of packing element 86 as tool 80 is rotated and translated into or through BOP 80 in downward direction 328 along tool axis 309 or BOB axis 89. The plurality of cutting edges 324 extend about tool axis 109, providing 360 degrees of downward-facing cutting surface. The plurality of cutting edges 325 face generally in the upward direction 329 and are thereby oriented to trim the elastomer of packing element 86 as tool 80 is rotated and translated back through or from BOP 80 in the upward direction 329 along tool axis 309 or BOB axis 89. The plurality of cutting edges 325 extend about tool axis 109, providing 360 degrees of upward-facing cutting surface. Cutting edges 325 are axially aligned with cutting edges 324, and alternating, neighboring cutting edges 324, 325 are separated by diagonally-extending flutes 326, which extend radially inward, to accommodate cutting and debris removal and to allow fluid movement. In the example of FIGS. 16 and 17, the diagonally-extending cutting edges 324, 325 and flutes 326 extend along helical paths. In this example, cutter 310 includes four flutes 326 that separate eight cutting edges 324. Outer surface 318 has an outer diameter OD_318 that is similar to the outside diameter OD_143 of tool 110 (FIG. 1) in relationship to the outside diameter, OD_185, of debris catcher 114 and the inside diameter, ID_93, of packing element 86. Receptacle 178 of debris catcher 114 faces upward and is open toward cutter 310 and the downward facing blades 324. For embodiments of tool 300 that include an upper debris catcher 112, the receptacle 178 of debris catcher 112 faces downward and is open toward cutter 310 and the upward facing blades 325.

While exemplary embodiments have been shown and described, modifications thereof can be made by one of ordinary skill in the art without departing from the scope or teachings herein. The embodiments described herein are exemplary only and are not limiting. Many variations, combinations, and modifications of the systems, apparatuses, and processes described herein are possible and are within the scope of the disclosure. Accordingly, the scope of protection is not limited to the embodiments described herein, but is only limited by the claims that follow, the scope of which shall include all equivalents of the subject matter of the claims. The inclusion of any particular method step or operation within the written description or a Figure does not necessarily mean that the particular step or operation is necessary to the method. The steps or operations of a method listed in the specification or the claims may be performed in any feasible order, except for those particular steps or operations, if any, for which a sequence is expressly stated. In some implementations two or more of the method steps or operations may be performed in parallel, rather than serially.

What is claimed is:

1. A trimming tool suitable for trimming material from within a central opening of an annular seal member, the tool comprising:
a tubular member extending along a tool axis;
a cutter coupled to move with the tubular member and including:
a first cutting edge oriented to cut when the tubular member is moved in a first direction along the tool axis, and
a second cutting edge oriented to cut when the tubular member is moved in a second direction along the tool axis that is different from the first direction; and
a first debris catcher and a second debris catcher mounted on the tubular member, each debris catcher comprising a receptacle that is open toward the cutter, and comprising an outer surface that includes a tapered segment;
wherein the cutter is mounted to the tubular member at a position between the first and second debris catchers.

2. The trimming tool of claim 1 wherein the tubular member comprises first and second ends spaced-apart along the tool axis; and
wherein the first cutting edge faces generally toward the first end and the second cutting edge faces generally away from the first cutting edge and toward the second end.

3. The trimming tool of claim 1 wherein second cutting edge is axially spaced from the first cutting edge, and wherein the first and second cutting edges extend about the tool axis.

4. The trimming tool of claim 3 wherein the first or the second cutting edge defines a plane that is not perpendicular with respect to the tool axis.

5. The trimming tool of claim 1 wherein the cutter comprises:
a first plurality of cutting edges configured to cut when the tubular member is moved in the first direction along the tool axis, wherein the first plurality of cutting edges includes the first cutting edge; and
a second plurality of cutting edges configured to cut when the tubular member is moved in the second direction along the tool axis, wherein the second plurality of cutting edges includes the second cutting edge.

6. The trimming tool of claim 5 wherein second plurality of cutting edges are separated from the first plurality of cutting edges by a plurality of flutes.

7. A trimming tool suitable for trimming elastomeric material from within a central opening of an annular seal member, the tool comprising:
an elongate pipe string extending along a tool axis and having first and second spaced-apart ends;
a cutter positioned on the pipe string at a location that is between the first end and the second end, the cuter comprising a cylindrical outer surface and at least one cutting edge that extend about the tool axis; and
a debris catcher mounted on the pipe string at a location between the cutter and one of the first and second ends, the debris catcher comprising an inner surface forming a receptacle that is open in the direction facing the cutter, and comprising an outer surface having an outer profile that includes at least one tapered segment.

8. The trimming tool of claim 7 wherein the cutter comprises a first edge cutting edge and a second cutting edge that is axially spaced along the tool axis from the first cutting edge, and wherein each of the cutting edges extend about the tool axis.

9. The trimming tool of claim 8 wherein at least one of the cutting edges defines a plane that is not perpendicular with respect to the tool axis.

10. The trimming tool of claim 9 wherein each of the cutting edges defines a plane that is not perpendicular with respect to the tool axis, and wherein the planes defined by the cutting edges are parallel.

11. The trimming tool of claim 9 wherein the plane defined by the cutting edge that is not perpendicular extends at an angle of between 60 degrees and 80 degrees relative to the axis.

12. The trimming tool of claim 7 comprising a first and a second debris catcher mounted on the pipe string, each of the debris catchers comprising an inner surface forming a receptacle that is open in the direction facing the cutter, and comprising an outer surface having an outer profile that includes a tapered segment.

13. The trimming tool of claim 12 wherein the pipe string comprises an upper pipe section, a central pipe section, and a lower pipe section;
wherein each pipe section comprises a threaded segment on its external surface;
wherein the first debris catcher comprises a threaded aperture that threadedly engages the threaded segment of the upper pipe section, and
wherein the second debris catcher comprises a threaded aperture that threadedly engages the threaded segment of the lower pipe section.

14. The trimming tool of claim 13 wherein the distance between the cutter and the first debris catcher is different than the distance between the cutter and the second debris catcher.

15. The trimming tool of claim 13 wherein the distance between at least one of the debris catchers and the cutter is adjustable.

16. The trimming tool of claim 15 comprising: a grove in the outer surface of at least one of the pipe sections, the groove being parallel to the tool axis; and a pin extending through one of the debris catchers and into the groove.

17. The trimming tool of claim 7 wherein at least one of the cutter and the debris catcher is pinned to the pipe section so as to fix its axial position and to prevent its rotation about the pipe string.

18. A trimming tool suitable for trimming material from within an annular seal member while the annular seal member is installed within a piece of equipment that is mounted to a wellhead, the tool comprising:
a pipe string extending along a longitudinal axis;
a cutter mounted on the pipe string and having a first cutting edge facing generally in a first axial direction along the longitudinal axis; and
a first debris catcher mounted on the pipe string at a location spaced-apart from the cutter and extending circumferentially around the pipe string, the debris catcher comprising a receptacle that faces the first cutting edge.

19. The trimming tool of claim 18 wherein the cutter includes a second cutting edge facing generally in a second axial direction along the longitudinal axis; and
wherein the trimming tool comprises a second debris catcher mounted on the pipe string and having a receptacle that faces the second cutting edge.

20. The trimming tool of claim 19 wherein the pipe string comprises upper, central, and lower pipe sections; and
wherein first debris catcher is coupled along the upper pipe section, the cutter 110 is coupled along the central pipe section, and lower debris catcher is coupled along the lower pipe section;

21. The trimming tool of claim 18 wherein the outer surface of the first debris catcher has an outside diameter that is equal to or greater than the outside diameter of the cutter.
